(19) United States
(12) Patent Application Publication
(10) Pub. No.: US 2026/0249508 A1
(43) Pub. Date: Aug. 27, 2026

(54) CHAIN SAW

(71) Applicant: Makita Corporation, Anjo-shi (JP)

(72) Inventor: Daisuke SUZUKI, Anjo-shi (JP)

(73) Assignee: Makita Corporation, Anjo-shi (JP)

(21) Appl. No.: 19/537,710

(22) Filed: Feb. 12, 2026

(30) Foreign Application Priority Data
Feb. 27, 2025 (JP) 2025-030660

(51) Int. Cl. B27B 17/00; B27B 17/02; B27B 17/08

(52) U.S. Cl. CPC B27B 17/0008; B27B 17/02; B27B 17/083

(57) ABSTRACT

A chain saw may include: a saw chain; a guide bar extending in a front-rear direction and to which the saw chain is attached; a sprocket configured to have the saw chain run along a periphery of the guide bar; a motor configured to rotate the sprocket about a rotation axis extending in a left-right direction; a battery pack configured to supply electric power to the motor; a body housing which accommodates the motor and holds the guide bar; and a top handle disposed above the body housing and configured to be gripped by a user. When the chain saw is viewed from a right side, a lower end of the battery pack may be positioned above a center line of the guide bar.

### CROSS REFERENCE TO RELATED APPLICATIONS

This application claims priority to Japanese Patent Application No. 2025-030660, filed on February 27, 2025, the entire contents of which are hereby incorporated by reference into the present application.

### TECHNICAL FIELD

The disclosure herein relates to a chain saw.

### BACKGROUND ART

European Patent No. 2747949 describes a chain saw. The chain saw includes: a saw chain; a guide bar extending in a front-rear direction and to which the saw chain is attached; a sprocket configured to have the saw chain run along a periphery of the guide bar; a motor configured to rotate the sprocket about a rotation axis extending in a left-right direction; a battery pack configured to supply electric power to the motor; a body housing which accommodates the motor; and a top handle disposed above the body housing and configured to be gripped by a user. When the chain saw is viewed from a right side, a lower end of the battery pack is positioned below a center line of the guide bar.

### SUMMARY

Generally, battery packs possess a certain weight, thus in a chain saw like the one described above, moment of inertia around the top handle is large. This may reduce ease of operation when a user grips the top handle to turn the chain saw to be oriented laterally. This specification discloses an art configured to reduce moment of inertia around a top handle.

A chain saw disclosed herein may comprise: a saw chain; a guide bar extending in a front-rear direction and to which the saw chain is attached; a sprocket configured to have the saw chain run along a periphery of the guide bar; a motor configured to rotate the sprocket about a rotation axis extending in a left-right direction; a battery pack configured to supply electric power to the motor; a body housing which accommodates the motor and holds the guide bar; and a top handle disposed above the body housing and configured to be gripped by a user. When the chain saw is viewed from a right side, a lower end of the battery pack may be positioned above a center line of the guide bar.

Another chain saw disclosed herein may comprise: a saw chain; a guide bar extending in a front-rear direction and to which the saw chain is attached; a sprocket configured to have the saw chain run along a periphery of the guide bar; a motor configured to rotate the sprocket about a rotation axis extending in a left-right direction; a battery pack configured to supply electric power to the motor; a body housing which accommodates the motor and holds the guide bar; and a top handle disposed above the body housing and configured to be gripped by a user. In a state where the chain saw rests on a resting surface, a height of a center of gravity of the battery pack in a vertical direction from the resting surface may be equal to or more than a half of a height of an upper end of the top handle in the vertical direction from the resting surface.

Yet another chain saw disclosed herein may comprise: a saw chain; a guide bar extending in a front-rear direction and to which the saw chain is attached; a sprocket configured to have the saw chain run along a periphery of the guide bar; a motor configured to rotate the sprocket about a rotation axis extending in a left-right direction; a battery pack configured to supply electric power to the motor; a body housing which accommodates the motor and holds the guide bar; and a top handle disposed above the body housing and configured to be gripped by a user. A trigger switch configured to be operated by the user may be disposed on a lower surface of a front end of the top handle. When the chain saw is viewed from a right side, a distance from a reference line which is extension of a center line at the front end of the top handle to a lower end of the battery pack may be equal to or less than 2.6 times a width of the front end of the top handle in a direction perpendicular to the center line.

### BRIEF DESCRIPTION OF DRAWINGS

FIG. 1 illustrates a perspective view of a chain saw 2 according to an embodiment.

FIG. 2 illustrates a right side view of the chain saw 2 according to the embodiment.

FIG. 3 illustrates a perspective view of the chain saw 2 according to the embodiment with a battery pack BT removed from a battery pack receptacle part 22c.

FIG. 4 illustrates a left side view of the chain saw 2 according to the embodiment with a side handle 14, a hand guard 16, and a left housing 10 removed.

FIG. 5 illustrates a lateral cross-sectional view of a motor 36 and its surroundings in the chain saw 2 according to the embodiment.

FIG. 6 illustrates a vertical cross-sectional view of a control device 42 and its surroundings in the chain saw 2 according to the embodiment.

FIG. 7 illustrates a right side view of the chain saw 2 according to the embodiment with a sprocket cover 20 removed.

FIG. 8 illustrates a right side view of the chain saw 2 according to the embodiment with the sprocket cover 20 and an outer cover plate 72 removed.

FIG. 9 illustrates a right side view of the chain saw 2 according to the embodiment, with the sprocket cover 20, the outer cover plate 72, a guide bar 6, an inner cover plate 70, a brake cover 18, and a brake drum cover 98 removed.

FIG. 10 illustrates a lateral cross-sectional view of the guide bar 6 and its surroundings in the chain saw 2 according to the embodiment in an upper cross section including an upper rear end part 6c of the guide bar 6.

FIG. 11 illustrates a lateral cross-sectional view of the guide bar 6 and its surroundings in the chain saw 2 according to the embodiment in a lower cross section including a lower rear end part 6d of the guide bar 6.

FIG. 12 illustrates a perspective view of the chain saw 2 according to the embodiment, with the sprocket cover 20, the outer cover plate 72, the guide bar 6, the inner cover plate 70, and the brake cover 18 removed.

FIG. 13 illustrates a perspective view of an inner sprocket cover 21a in the chain saw 2 according to the embodiment.

FIG. 14 illustrates a right side view of the chain saw 2 according to the embodiment in a state of being placed on a resting surface P.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved chain saws, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

A chain saw disclosed herein may comprise: a saw chain; a guide bar extending in a front-rear direction and to which the saw chain is attached; a sprocket configured to have the saw chain run along a periphery of the guide bar; a motor configured to rotate the sprocket about a rotation axis extending in a left-right direction; a battery pack configured to supply electric power to the motor; a body housing which accommodates the motor and holds the guide bar; and a top handle disposed above the body housing and configured to be gripped by a user. When the chain saw is viewed from a right side, a lower end of the battery pack may be positioned above a center line of the guide bar.

In the above configuration, since the battery pack, which is a heavy object, is positioned relatively close to the center line of the top handle and/or its extension line, moment of inertia around the top handle is small.

Another chain saw disclosed herein may comprise: a saw chain; a guide bar extending in a front-rear direction and to which the saw chain is attached; a sprocket configured to have the saw chain run along a periphery of the guide bar; a motor configured to rotate the sprocket about a rotation axis extending in a left-right direction; a battery pack configured to supply electric power to the motor; a body housing which accommodates the motor and holds the guide bar; and a top handle disposed above the body housing and configured to be gripped by a user. In a state where the chain saw rests on a resting surface, a height of a center of gravity of the battery pack in a vertical direction from the resting surface may be equal to or more than a half of a height of an upper end of the top handle in the vertical direction from the resting surface.

With the above configuration also, since the battery pack, which is a heavy object, is positioned relatively close to the center line of the top handle and/or its extension line, moment of inertia around the top handle is small.

Yet another chain saw disclosed herein may comprise: a saw chain; a guide bar extending in a front-rear direction and to which the saw chain is attached; a sprocket configured to have the saw chain run along a periphery of the guide bar; a motor configured to rotate the sprocket about a rotation axis extending in a left-right direction; a battery pack configured to supply electric power to the motor; a body housing which accommodates the motor and holds the guide bar; and a top handle disposed above the body housing and configured to be gripped by a user. A trigger switch configured to be operated by the user may be disposed on a lower surface of a front end of the top handle. When the chain saw is viewed from a right side, a distance from a reference line which is extension of a center line at the front end of the top handle to a lower end of the battery pack may be equal to or less than 2.6 times a width of the front end of the top handle in a direction perpendicular to the center line.

With the above configuration also, since the battery pack, which is a heavy object, is positioned relatively close to the center line of the top handle and/or its extension line, moment of inertia around the top handle is small.

In one or more embodiments, the chain saw may further comprise a control device configured to control operation of the motor. When the chain saw is viewed from a rear side, the motor may at least partially overlap the control device.

In the above configuration, the dimensions of the chain saw in the up-down direction can be made smaller.

In one or more embodiments, the chain saw may further comprise a control device configured to control operation of the motor. When the chain saw is viewed from below, the battery pack may at least partially overlap the control device.

In the above configuration, the dimensions of the chain saw in the front-rear direction can be made smaller.

In one or more embodiments, the battery pack may be configured to be detachably attached to the body housing by being slid in a left-right direction.

In the above configuration, the user can attach and detach the battery pack to and from the body housing by sliding the battery pack in the left-right direction.

### Embodiment

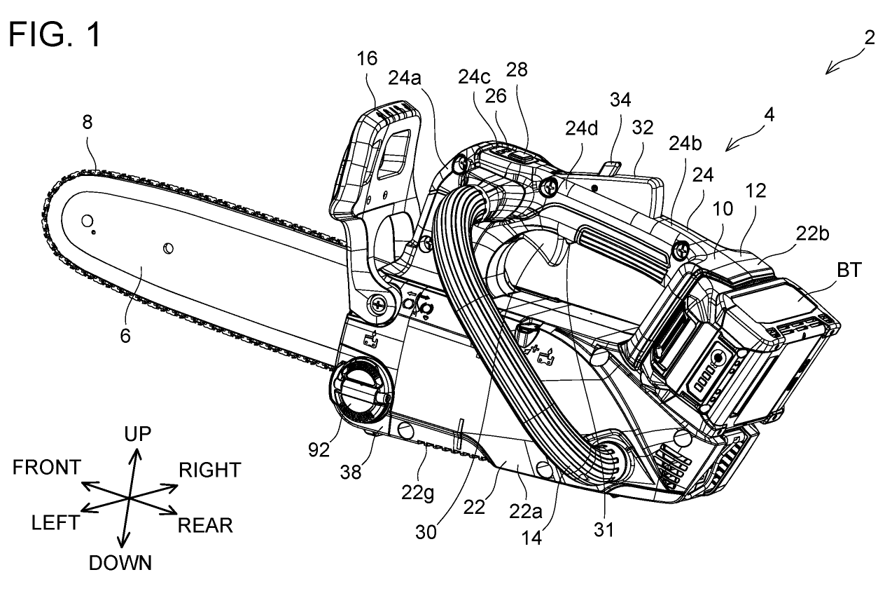

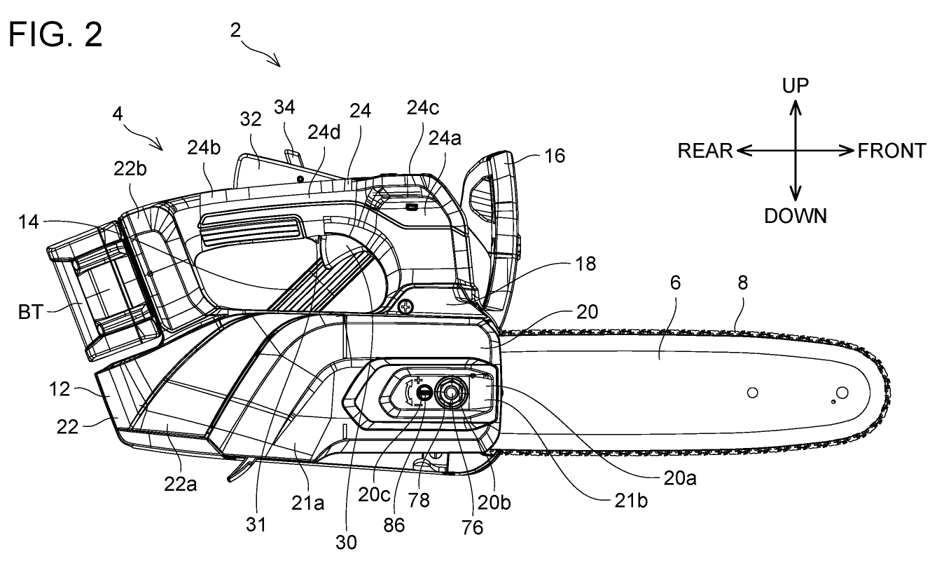

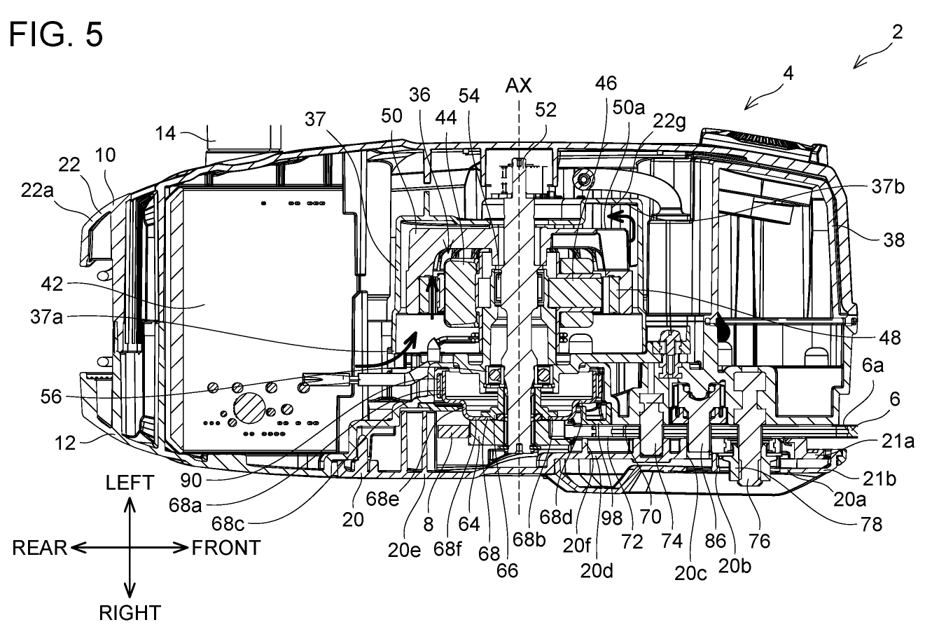

As illustrated in FIGS. 1, 2, a chain saw 2 according to the present embodiment comprises a body 4, a guide bar 6, and a saw chain 8. The guide bar 6 is an elongated plate-shaped member that is attached to the body 4 so as to protrude frontward from the body 4. The saw chain 8 comprises a plurality of cutters interconnected to each other and attached along the periphery of the guide bar 6. A battery pack BT is attached to the body 4. The battery pack BT incorporates a plurality of secondary battery cells (not shown) therein, and is configured rechargeable with an external power supply. The chain saw 2 cuts a sawing target such as wood by driving the motor 36 (see FIG. 5) with electric power supplied from the battery pack BT and thereby causing the saw chain 8 to run along the periphery of the guide bar 6. Here, in the following description, the longitudinal direction of the guide bar 6 will be termed a front-rear direction of the chain saw 2, a direction perpendicular to the front-rear direction will be termed an up-down direction of the chain saw 2, and a direction perpendicular to the front-rear direction and the up-down direction will be termed a left-right direction of the chain saw 2. Here, it should be noted that illustration of the saw chain 8 is omitted for clearer illustration in some of the drawings.

The body 4 comprises a left housing 10, a right housing 12, a side handle 14, a hand guard 16, a brake cover 18, and a sprocket cover 20. A body housing 22 and a top handle 24 are formed by the left housing 10 and the right housing 12. The left housing 10 forms the outer shape of the left-half surfaces of the body housing 22 and the top handle 24, whereas the right housing 12 forms the outer shape of right half surfaces of the body housing 22 and the top handle 24. The sprocket cover 20 comprises an inner sprocket cover 21a and an outer sprocket cover 21b disposed in contact with the outer surface of the inner sprocket cover 21a.

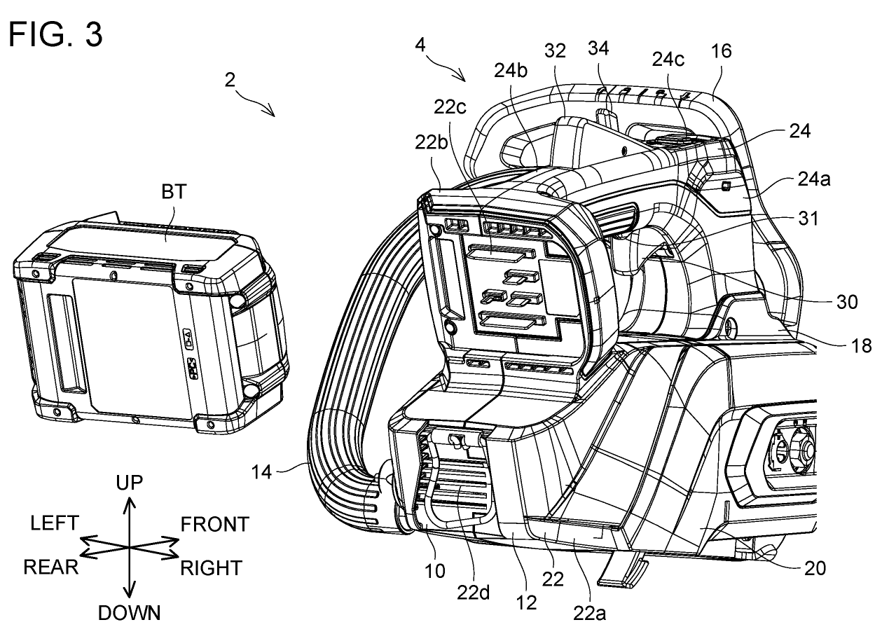

The body housing 22 comprises a lower body housing 22a having a substantially cuboid shape with its longitudinal direction as the front-rear direction of the body 4 and an upper body housing 22b extending to a rear upper side from a rear upper portion of the lower body housing 22a. As illustrated in FIG. 3, the rear surface of the upper body housing 22b comprises a battery pack receptacle part 22c configured to have the battery pack BT detachably attached thereto by sliding the battery pack BT in the left-right direction. A user can attach the battery pack BT to the battery pack receptacle part 22c, by sliding the battery pack BT rightward with his/her left hand while gripping the top handle 24 with his/her right hand. Likewise, the user can detach the battery pack BT from the battery pack receptacle part 22c, by sliding the battery pack BT leftward with his/her left hand while gripping the top handle 24 with his/her right hand.

As illustrated in FIG. 1, the top handle 24 comprises a support part 24a having a substantially square columnar shape extending upward from a front upper surface of the lower body housing 22a and a grip part 24b extending to a rear lower side from a rear upper portion of the support part 24a and connected to an upper front surface of the upper body housing 22b. The cross-sectional shape of the grip part 24b is a substantially circular shape. A recess part 24c is defined on the upper surface of the support part 24a. Inside the recess part 24c, a power switch 26 which the user uses to switch the power of the chain saw 2 on/off, and a power lamp 28 which displays the on/off state of the power of the chain saw 2 are arranged. The front end of the grip part 24b comprises a front end grip part 24d extending linearly, and a trigger switch 30 for the user to operate rotation of the saw chain 8 is arranged on the lower surface of the front end grip part 24d. A trigger lock lever 32 configured to switch between a state of permitting the user to operate the trigger switch 30 and a state of prohibiting the user from operating the trigger switch 30 is arranged on the upper portion of the grip part 24b. A lock pin 34 is rotatably supported onto the trigger lock lever 32 and a portion of the lock pin 34 is exposed from the upper surface of the trigger lock lever 32.

The side handle 14 has an outer shape of a substantially U shape connecting an upper rear left surface of the support part 24a of the top handle 24 and a lower rear left surface of the lower body housing 22a. The cross-sectional shape of the side handle 14 is a substantially circular shape. When the user is using the chain saw 2, he/she grips the top handle 24 with his/her right hand and grips the side handle 14 with his/her left hand to hold the chain saw 2. When the user rotates the lock pin 34 of the top handle 24 to press the same into the trigger lock lever 32 from this state, and presses down the trigger lock lever 32 with the palm of his/her right hand, the user is now permitted to operate the trigger switch 30. When the user pulls the trigger switch 30 upward with the index finger of his/her right hand in this state, the saw chain 8 is driven to rotate.

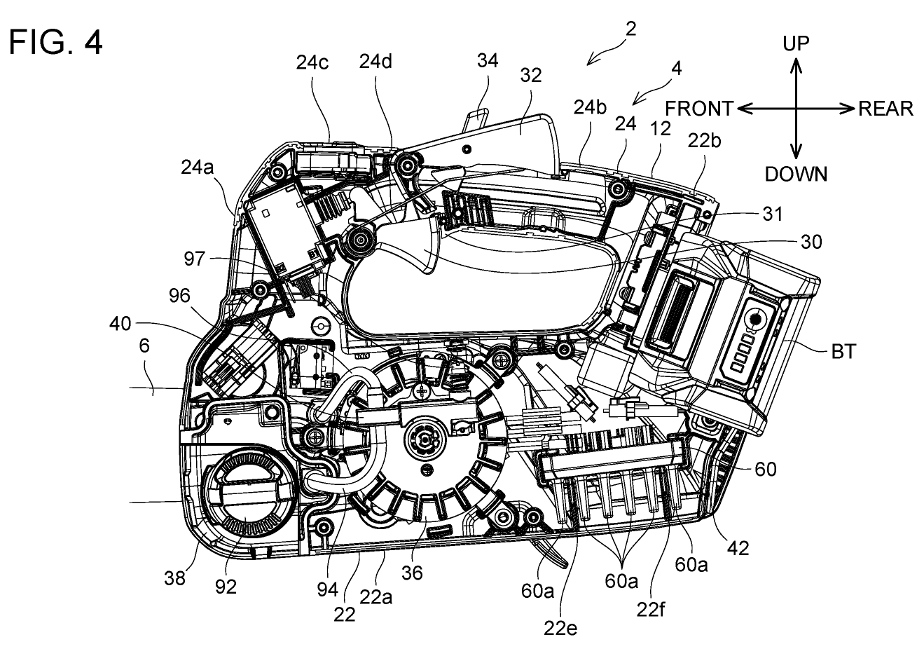

As illustrated in FIG. 4, the motor 36, an oil tank 38, an oil pump 40, and a control device 42 are accommodated in the lower body housing 22a. The oil tank 38 is arranged frontward of the motor 36 and the oil pump 40. The control device 42 is arranged rearward of the motor 36 and the oil pump 40.

When the chain saw 2 is viewed from the rear side, the oil tank 38 partially overlaps each of the motor 36, the control device 42, and the battery pack BT. When the chain saw 2 is viewed from the rear side, the motor 36 partially overlaps each of the control device 42 and the battery pack BT. When the chain saw 2 is viewed from the rear side, the battery pack BT partially overlaps the trigger switch 30.

When the chain saw 2 is viewed from below, the oil tank 38 does not overlap any of the motor 36, the control device 42, and the battery pack BT. When the chain saw 2 is viewed from below, the motor 36 does not overlap the control device 42 nor the battery pack BT. When the chain saw 2 is viewed from below, the control device 42 partially overlaps the battery pack BT.

As illustrated in FIG. 5, the motor 36 is a DC brushless motor with an outer rotor. The motor 36 rotates about a rotation axis AX extending in the left-right direction. The motor 36 comprises a stator 46 around which a coil 44 is wrapped, a rotor 48 arranged radially outward of the stator 46, a cooling fan 50 fitted into the rotor 48, and an output shaft 52 extending through centers of the stator 46 and the rotor 48 and fitted into the cooling fan 50. The coil 44, the stator 46, the rotor 48, and the cooling fan 50 are accommodated in a motor casing 37. The motor casing 37 and the stator 46 are fixed relative to the body housing 22. The coil 44 of the stator 46 is connected to the control device 42. The output shaft 52 is arranged along the left-right direction of the chain saw 2 and is rotatably supported by the body housing 22 via bearings 54, 56.

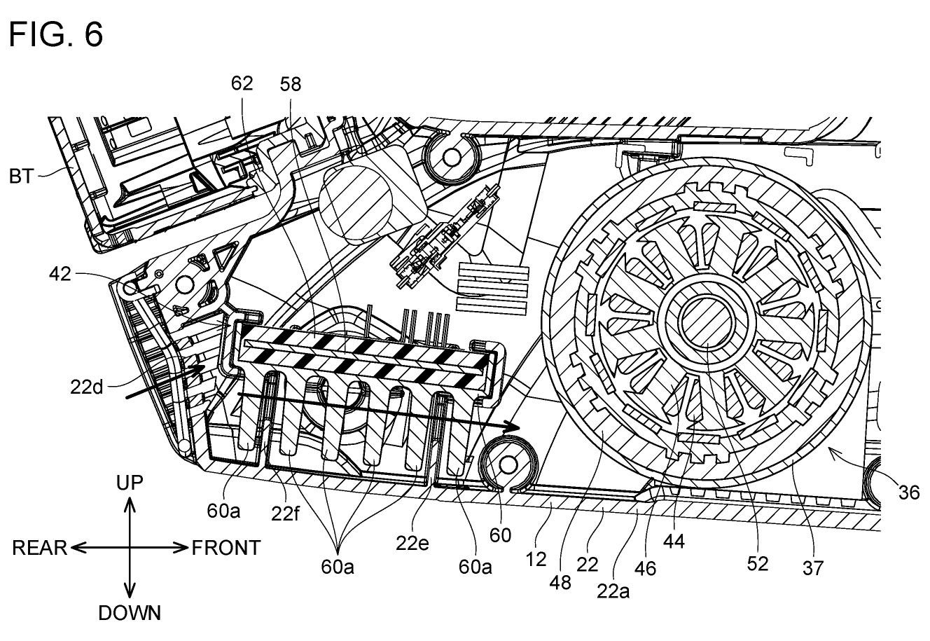

As illustrated in FIG. 6, the control device 42 is fixed to the lower body housing 22a. The control device 42 comprises a circuit board 58, a case 60, and potting material 62. The circuit board 58 is accommodated in the case 60. The circuit board 58 comprises a plurality of switching elements (not shown) and a microcomputer (not shown). The switching elements are for example IGBTs or MOSFETs. The microcomputer controls operation of the motor 36 by switching the on state and the off state of the switching elements. The case 60 has a box shape with an opening at its top. The case 60 comprises a plurality of heat dissipating fins 60a arranged along the front-rear direction and the left-right direction of the case 60. Each of the plurality of heat dissipating fins 60a has a square columnar shape, and protrudes downward from the lower surface of the case 60 perpendicularly to the lower surface of the case 60. The potting material 62 is constituted of, for example, resin. The potting material 62 is disposed within the case 60 by being poured into the case 60 in a molten state and being cured. The potting material 62 encapsulates the circuit board 58 therein.

Next, the flow of air when the cooling fan 50 rotates will be described. In FIGS. 5, 6, the flow of air is shown by arrows. As illustrated in FIG. 6, when the cooling fan 50 rotates, the air outside the body housing 22 flows through an air inlet 22d into the body housing 22. The air having flowed into the body housing 22 flows to a position frontward of the control device 42 after flowing through gaps between the heat dissipating fins 60a. While the air is flowing between the heat dissipating fins 60a, the heat of the control device 42 is released from the heat dissipating fins 60a to the air. In the present embodiment, the body housing 22 comprises a front rib 22e and a rear rib 22f that extend inward from the wall surface of the body housing 22. Each of the front rib 22e and the rear rib 22f has a substantially planer shape. In a direction in which the heat dissipating fins 60a extend, the tip of the front rib 22e and the tip of the rear rib 22f are positioned between the tips and the roots (i.e., joint portions between the heat dissipating fins 60a and the lower surface of the case 60) of the heat dissipating fins 60a. Due to this, the air flows between surroundings of the roots of the heat dissipating fins 60a. Since the roots of the heat dissipating fins 60a are positioned near the circuit board 58, the heat of the control device 42 can be released from the roots of the heat dissipating fins 60a to the air, as a result of which the control device 42 can be effectively cooled.

As illustrated in FIG. 5, the air having flowed to the position frontward of the control device 42 flows through an air supply opening 37a into the motor casing 37. The air having flowed into the motor casing 37 flows in a gap between the stator 46 and the rotor 48, cools the stator 46 and the rotor 48 and then arrives at the cooling fan 50. The air having arrived at the cooling fan 50 flows radially outward along blades 50a, and then flows circumferentially along the inner surface of the motor casing 37 to flow through an air discharge opening 37b of the motor casing 37 and an air outlet 22g of the body housing 22 and is discharged outside the body housing 22.

As illustrated in FIG. 5, a sprocket 64 and a brake base 66 are fixed around the right-side end part of the output shaft 52. The sprocket 64 and the brake base 66 are arranged on the right side of the bearing 56. A brake drum 68 fits into the brake base 66. The brake drum 68 comprises a base part 68a and a projecting part 68b protruding outward (i.e., to the right of the chain saw 2) from the base part 68a. The base part 68a comprises a circular cylinder part 68c and a flange part 68d disposed outside of the circular cylinder part 68c and having its diameter reduced from the circular cylinder part 68c. The projecting part 68b comprises a circular cylinder part 68e having an outer diameter smaller than an outer diameter of the circular cylinder part 68c and a flange part 68f disposed outside of the circular cylinder part 68e and having its diameter reduced from the circular cylinder part 68e. The flange part 68f of the projecting part 68b is in contact with the sprocket 64.

The sprocket 64 is exposed on the outside of the right housing 12. The saw chain 8 (see FIG. 1) is stretched over the sprocket 64 from the guide bar 6. When the motor 36 is driven, the sprocket 64 rotates about the rotation axis AX of the motor 36 along with the output shaft 52, by which the saw chain 8 (see FIG. 1) runs along the sprocket 64 and the periphery of the guide bar 6. In the present embodiment, the rotation axis AX of the sprocket 64 coincides the rotation axis AX of the motor 36.

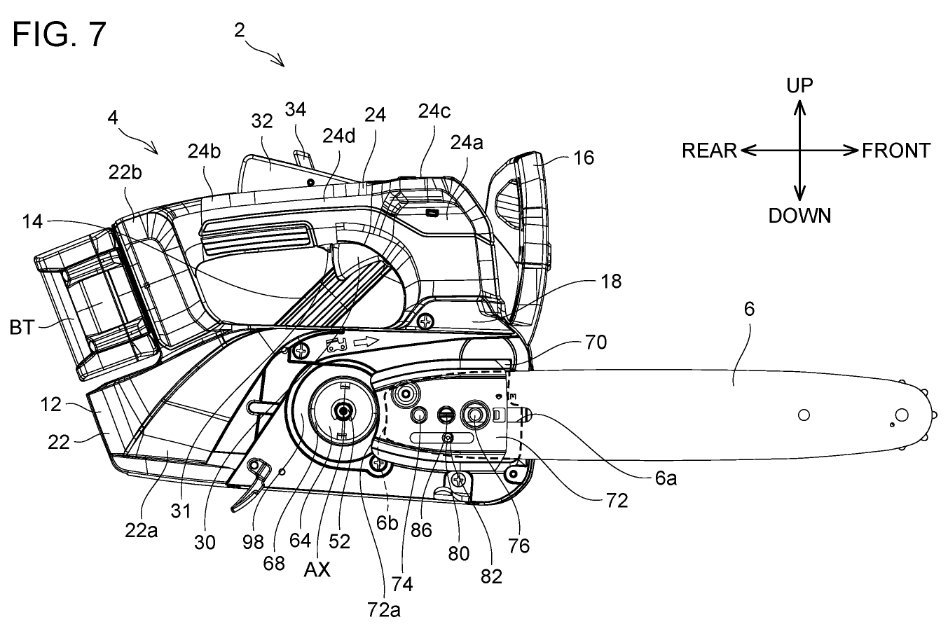

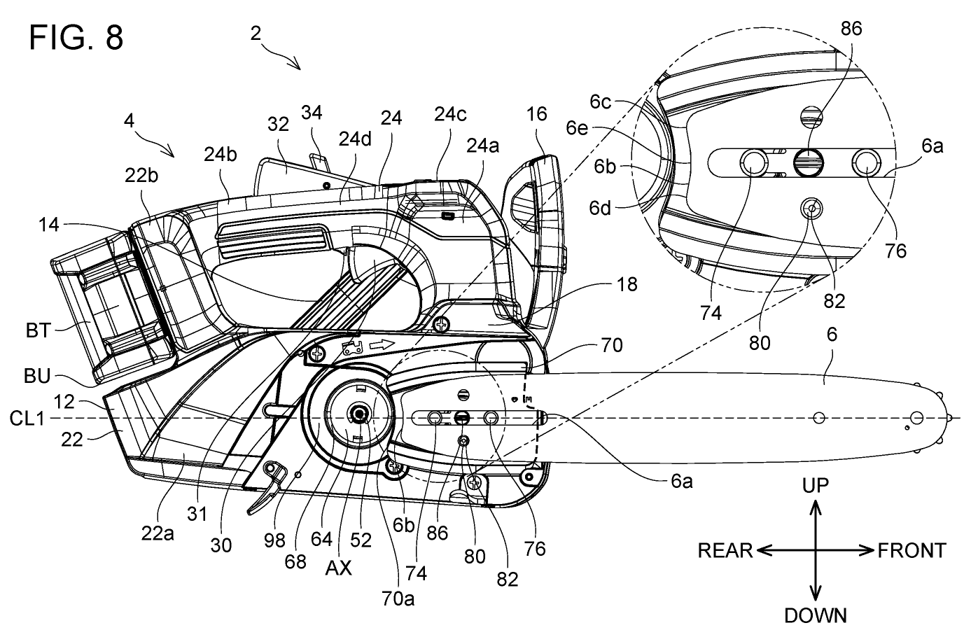

As illustrated in FIG. 7, the guide bar 6 is fixed to the right housing 12 with the guide bar 6 sandwiched between the inner cover plate 70 and the outer cover plate 72. The inner cover plate 70 has a shape that its upper end and its proximity and its lower end and its proximity are curved inward (i.e., to the left of the chain saw 2). The outer cover plate 72 has a shape that its upper end and its proximity and its lower end and its proximity are curved outward (i.e., to the right of the chain saw 2). As illustrated in FIG. 8, a long hole 6a extending along the longitudinal direction of the guide bar 6 (i.e., front-rear direction of the chain saw 2) is defined in the guide bar 6. The guide bar 6 is held in the body housing 22 via a support pin 74 and a support bolt 76 that extend through the long hole 6a. The support bolt 76 extends through the outer cover plate 72 (see FIG. 7) and the sprocket cover 20 (see FIG. 2) to protrude outside the sprocket cover 20. As illustrated in FIG. 2, a nut 78 which is fastened from outside the sprocket cover 20 is attached to the support bolt 76. The user can adjust the tension of the saw chain 8 by loosening the nut 78 and sliding the guide bar 6 in the front-rear direction, thereby changing the distance between the guide bar 6 and the sprocket 64.

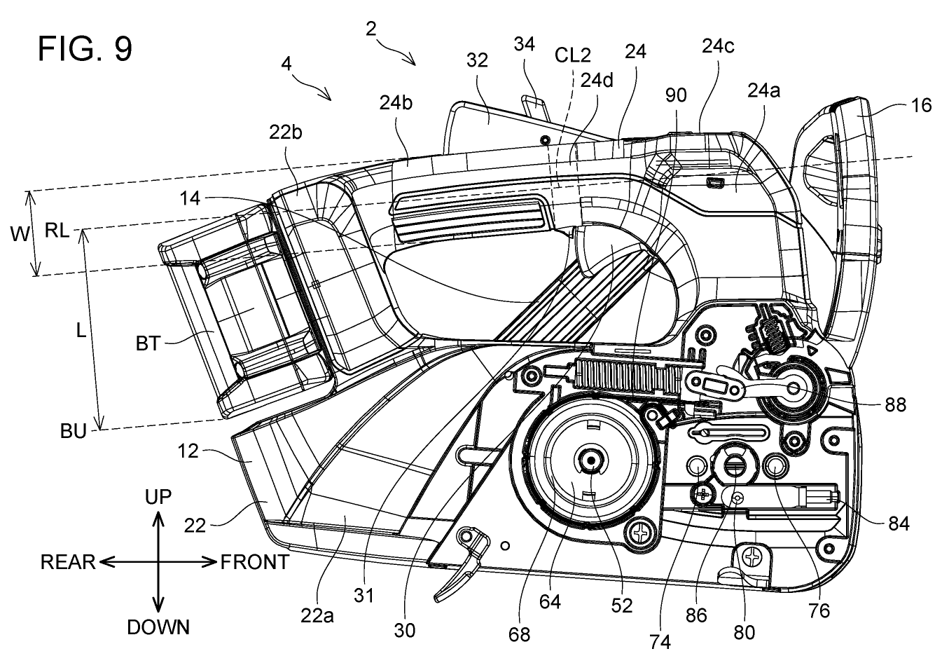

As illustrated in FIG. 8, an engagement hole 82, which engages with an engagement claw 80, is defined in the guide bar 6. As illustrated in FIG. 9, the engagement claw 80 is coupled to an adjusting screw 86 via a rotation-linear motion conversion mechanism 84. The rotation-linear motion conversion mechanism 84 converts the rotational movement of the adjusting screw 86 into linear movement of the engagement claw 80 in a direction along the long hole 6a (i.e., the front-rear direction). As illustrated in FIG. 8, the adjusting screw 86 extends through the long hole 6a without contacting the inner peripheral surface of the long hole 6a. When the user rotates the adjusting screw 86, the engagement claw 80 moves in the front-rear direction, thereby causing the guide bar 6 to slide in the front-rear direction of the chain saw 2. In this manner, the front-rear directional position of the guide bar 6 relative to the sprocket 64 can be adjusted.

As illustrated in FIG. 2, the sprocket 64, the inner cover plate 70, the outer cover plate 72, and the support pin 74 are covered by the sprocket cover 20. A recess part 20a is defined in the sprocket cover 20. A fastening opening 20b in which the support bolt 76 extends and an adjustment opening 20c for accessing the adjusting screw 86 from outside are defined in the recess part 20a. The nut 78 is fastened to the support bolt 76 from outside the recess part 20a. The user can fasten and loosen the nut 78 in a state where the sprocket cover 20 is attached. Further, the user can adjust the tension of the saw chain 8 by rotating the adjusting screw 86 through the adjustment opening 20c with the sprocket cover 20 attached.

As illustrated in FIG. 9, the hand guard 16 is coupled to a brake band 90 via a link mechanism 88. The link mechanism 88 and a portion of the brake band 90 are covered by the brake cover 18 (see FIG. 2). The hand guard 16 is configured to swing about a swing axis along the left-right direction of the chain saw 2. The brake band 90 is arranged so as to surround the circular cylinder part 68c (see FIG. 5) of the brake drum 68. When the hand guard 16 is tiled down frontward, the link mechanism 88 reduces the diameter of the brake band 90, whereas when the hand guard 16 is tiled down rearward, the link mechanism 88 increases the diameter of the brake band 90. When the diameter of the brake band 90 decreases, the inner peripheral surface of the brake band 90 and the outer peripheral surface of the circular cylinder part 68c of the brake drum 68 contact each other, by which friction between both of them limits the rotation of the output shaft 52.

The oil tank 38 shown in FIG. 1 is configured to store lubricant oil for lubricating the saw chain 8 therein. The oil tank 38 comprises a cap 92 configured to be detachably attached to a refill port for refilling the oil tank 38 with the lubricant oil. The cap 92 of the oil tank 38 is exposed on the outside of the left housing 10, and is arranged on the left surface of the front portion of the body housing 22.

As illustrated in FIG. 4, the oil pump 40 draws the lubricant oil from inside the oil tank 38 through an inlet tube 94, and supplies the lubricant oil to the guide bar 6 and the saw chain 8 (see FIG. 1) through an outlet tube 96 in association with the rotation of the motor 36. The discharge amount of the lubricant oil supplied by the oil pump 40 from the oil tank 38 to the guide bar 6 and the saw chain 8 (see FIG. 1) can be adjusted through an adjusting pin 97.

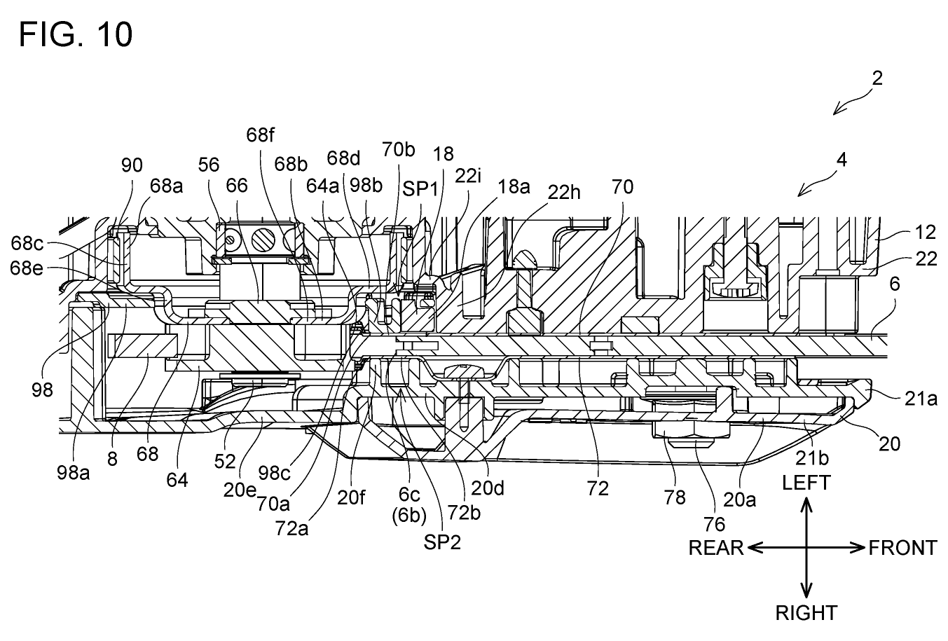

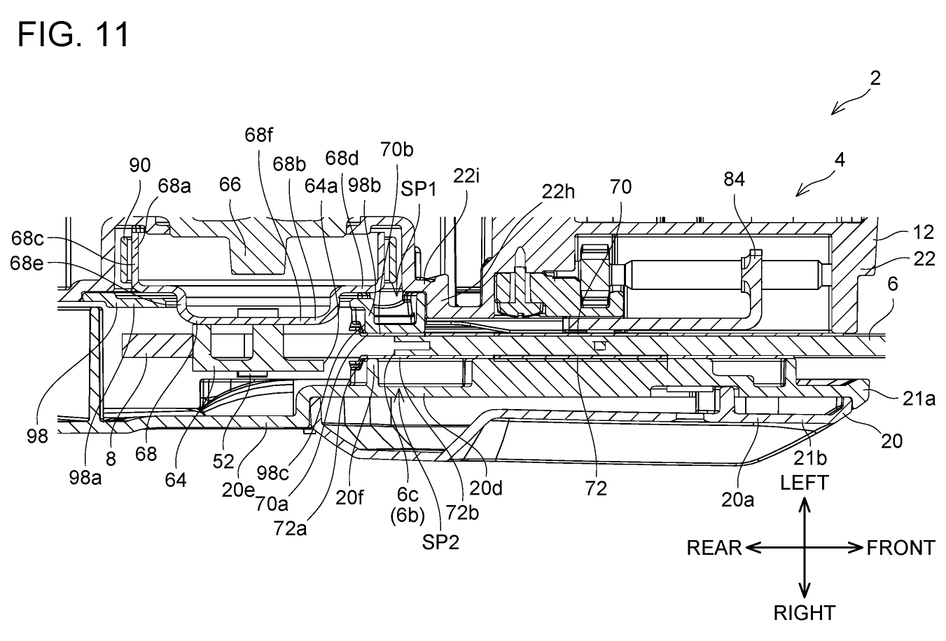

As illustrated in FIGS. 10, 11, a space SP1 is defined by the body housing 22, the brake drum 68, the sprocket 64, and the guide bar 6. A wall 22h extending in the left-right direction of the body housing 22 is arranged frontward of the space SP1, and a wall 22i extending in the front-rear direction of the body housing 22 and the flange part 68d of the brake drum 68 are arranged on the left of the space SP1. The circular cylinder part 68e of the brake drum 68 and an outer peripheral surface 64a of the sprocket 64 are arranged rearward of the space SP1, and the guide bar 6 is arranged on the right of the space SP1. When the space SP1 as such is formed, in the cutting operation using the chain saw 2, cutting debris may enter the space SP1 along with rotation of the saw chain 8 and the entering cutting debris may remain in the space SP1.

For the above concern, in the present embodiment, the inner cover plate 70 suppresses the entry of cutting debris into the space SP1. As illustrated in FIGS. 10, 11, the inner cover plate 70 is disposed between the body housing 22 and the guide bar 6.

As illustrated in FIG. 8, a rear end 6b of the guide bar 6 comprises an upper rear end part 6c protruding rearward above the center in the up-down direction of the guide bar 6, a lower rear end part 6d protruding rearward below the center in the up-down direction of the guide bar 6, and an intermediate rear end part 6e recessed frontward between the upper rear end part 6c and the lower rear end part 6d. In the guide bar 6 of the present embodiment, the position in the front-rear direction of the upper rear end part 6c is substantially the same as the position in the front-rear direction of the lower rear end part 6d.

As illustrated in FIGS. 10, 11, in the present embodiment, when the inner cover plate 70 is viewed in a certain cross section which extends in the front-rear and left-right directions and includes the rear end 6b of the guide bar 6 (i.e., the upper rear end part 6c, the lower rear end part 6d, or the intermediate rear end part 6e), the inner cover plate 70 is in contact with a surface of the guide bar 6 that faces the body housing 22 (i.e., left surface of the guide bar 6), and a rear end 70a of the inner cover plate 70 is positioned rearward of the rear end 6b of the guide bar 6. For example, as illustrated in FIG. 10, when the inner cover plate 70 is viewed in an upper cross section which extends in the front-rear direction and the left-right direction and includes the upper rear end part 6c of the guide bar 6, the inner cover plate 70 is in contact with the left surface of the guide bar 6, and the rear end 70a of the inner cover plate 70 is positioned rearward of the rear end 6b of the guide bar 6 (here, the upper rear end part 6c). Also, as illustrated in FIG. 11, when the inner cover plate 70 is viewed in the lower cross section which extends in the front-rear direction and the left-right direction and includes the lower rear end part 6d of the guide bar 6, the inner cover plate 70 is in contact with the left surface of the guide bar 6, the rear end 70a of the inner cover plate 70 is positioned rearward of the rear end 6b of the guide bar 6 (here, the lower rear end part 6d). These configurations can suppress the entry of cutting debris into the space SP1.

As illustrated in FIG. 8, the rear end 70a of the inner cover plate 70 is positioned rearward of the rear end 6b of the guide bar 6 and in proximity to the sprocket 64. Being “in proximity to the sprocket 64” herein may mean, for example, that the distance from the sprocket 64 in the radial direction of the rotation axis AX of the sprocket 64 is 1mm or less, and also may mean, for example, that the distance from the sprocket 64 in the radial direction of the rotation axis AX of the sprocket 64 is 0.5mm or less.

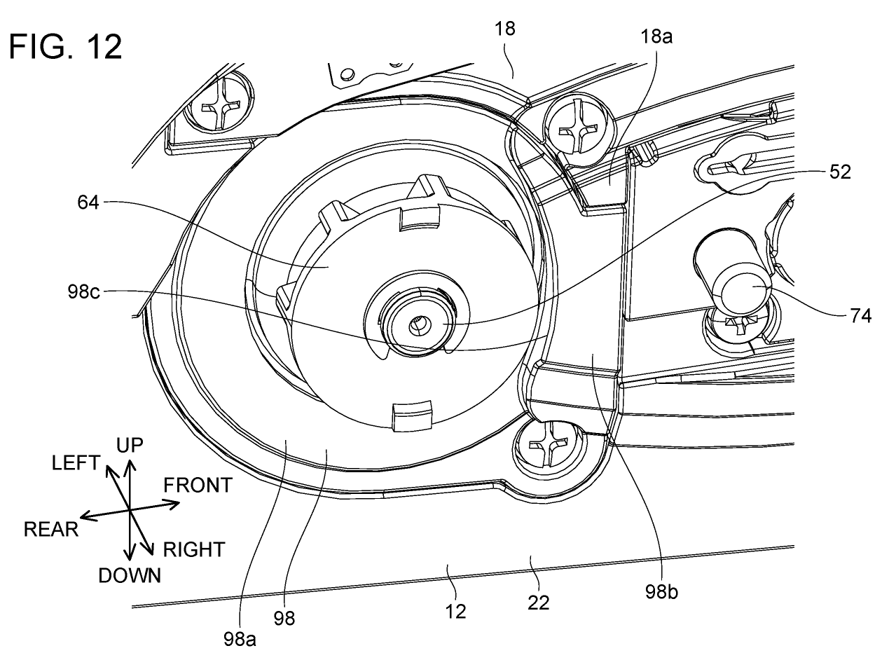

As illustrated in FIG. 12, the brake drum cover 98 is fixed to the right surface of the body housing 22. The brake drum cover 98 is disposed below the brake cover 18. The brake drum cover 98 comprises a circular part 98a surrounding the projecting part 68b (see FIG. 5) of the brake drum 68 and a protruding part 98b disposed at the front end of the circular part 98a and protruding more outward than the circular part 98a. As illustrated in FIGS. 10, 11, the brake drum cover 98 is disposed inward of the inner cover plate 70 (i.e., on left of the inner cover plate 70). The protruding part 98b is in contact with the left surface of the inner cover plate 70. The position in the front-rear direction of a rear end 98c of the protruding part 98b is substantially the same as the position in the front-rear direction of the rear end 70a of the inner cover plate 70.

As illustrated in FIG. 12, an intermediate lower end part 18a of the brake cover 18 is disposed between the body housing 22 and the protruding part 98b of the brake drum cover 98. As illustrated in FIG. 10, the brake cover 18 is positioned inward of the inner cover plate 70 (i.e., on left of the inner cover plate 70). The intermediate lower end part 18a is in contact with the left surface of the inner cover plate 70.

As illustrated in FIGS. 10, 11, a rear end part 70b of the inner cover plate 70, a part of the circular part 98a and the protruding part 98b of the brake drum cover 98, and the intermediate lower end part 18a of the brake cover 18 are arranged in the space SP1. Because the space SP1 is occupied by the rear end part 70b of the inner cover plate 70, a part of the circular part 98a and the protruding part 98b of the brake drum cover 98, and the intermediate lower end part 18a of the brake cover 18, the entry of cutting debris into the space SP1 and/or stagnation of the cutting debris in the space SP1 can be suppressed. In the present embodiment, a distance in the front-rear direction between the rear end part 70b of the inner cover plate 70 as well as the rear end 98c of the protruding part 98b of the brake drum cover 98 and the outer peripheral surface 64a of the sprocket 64 is 6mm or less, and also a distance in the left-right direction between the inner cover plate 70 as well as the protruding part 98b of the brake drum cover 98 and the left surface of the guide bar 6 is 3mm or less. Due to this, the entry of cutting debris into the space SP1 and/or stagnation of the cutting debris in the space SP1 can be effectively suppressed. Here, in a modification, the distance in the front-rear direction between the rear end part 70b of the inner cover plate 70 or the rear end 98c of the protruding part 98b of the brake drum cover 98 and the outer peripheral surface 64a of the sprocket 64 may be 6mm or less. Additionally or alternatively, the distance in the left-right direction between the inner cover plate 70 or the protruding part 98b of the brake drum cover 98 and the left surface of the guide bar 6 may be 3mm or less. In this configuration also, the entry of cutting debris into the space SP1 and/or stagnation of the cutting debris in the space SP1 can be effectively suppressed.

The circular part 98a of the brake drum cover 98 covers the base part 68a of the brake drum 68 (i.e., the circular cylinder part 68c and the flange part 68d) and a portion of the circular cylinder part 68e. Due to this, cutting debris is suppressed from accumulating and remaining in proximity to the outer peripheral surface of the brake drum 68 can be suppressed. Further, the brake drum cover 98 is fixed to the body housing 22 such that the brake drum cover 98 is detachable. Due to this, if cutting debris has entered the space SP1, the cutting debris can be easily removed by detaching the brake drum cover 98 from the body housing 22.

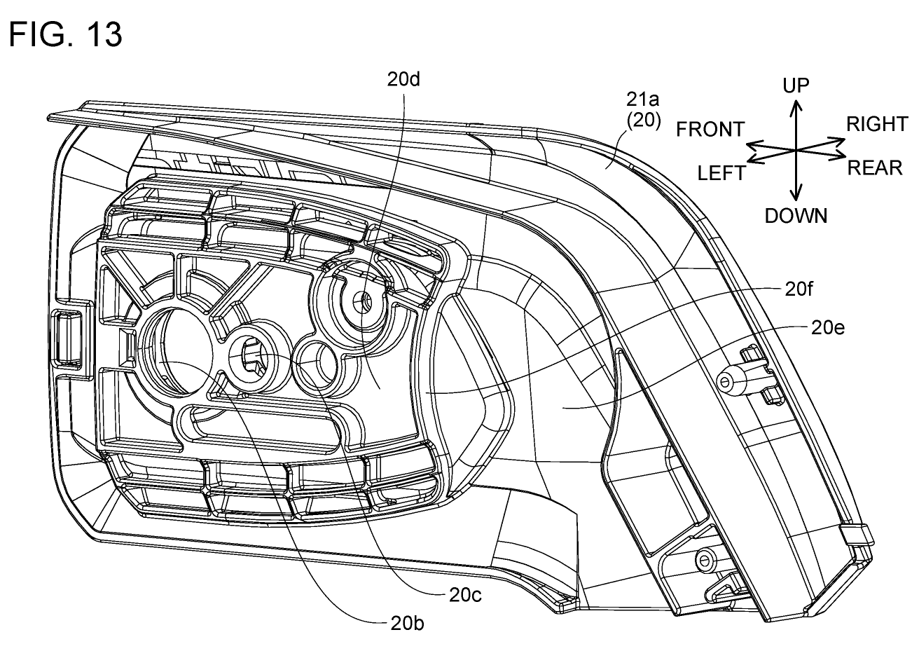

As illustrated in FIG. 13, a step part 20d of the sprocket cover 20 protrudes inward from a wall 20e forming the outer shape of the sprocket cover 20. As illustrated in FIGS. 10, 11, the step part 20d is arranged parallel to the guide bar 6.

As illustrated in FIGS. 10, 11, a space SP2 is formed by the support pin 74 (see FIG. 5), the sprocket cover 20, the sprocket 64, and the guide bar 6. The support pin 74 is arranged frontward of the space SP2, and the guide bar 6 is arranged on the left of the space SP2. The outer peripheral surface 64a of the sprocket 64 is arranged rearward of the space SP2, and the step part 20d of the sprocket cover 20 is arranged on the right of the space SP2. When the space SP2 as such is formed, during cutting operation using the chain saw 2, cutting debris may enter the space SP2 along with rotation of the saw chain 8 and the entering cutting debris may remain in the space SP2.

For the above concern, in the present embodiment, the outer cover plate 72 suppresses the entry of cutting debris into the space SP2. As illustrated in FIGS. 10, 11, the outer cover plate 72 is arranged between the sprocket cover 20 and the guide bar 6. The outer cover plate 72 is fixed to the sprocket cover 20.

In the present embodiment, when the outer cover plate 72 is viewed in a certain cross section which extends in the front-rear direction and the left-right direction and includes the rear end 6b of the guide bar 6, the outer cover plate 72 is in contact with a surface of the guide bar 6 that faces the sprocket cover 20 (i.e., the right surface of the guide bar 6), and a rear end 72a of the outer cover plate 72 is positioned rearward of the rear end 6b of the guide bar 6. For example, as illustrated in FIG. 10, when the outer cover plate 72 is viewed in the upper cross section which extends in the front-rear direction and the left-right direction and includes the upper rear end part 6c of the guide bar 6, the outer cover plate 72 is in contact with the right surface of the guide bar 6, and the rear end 72a of the outer cover plate 72 is positioned rearward of the rear end 6b of the guide bar 6 (here, the upper rear end part 6c). As illustrated in FIG. 11, when the outer cover plate 72 is viewed in the lower cross section which extends in the front-rear direction and the left-right direction and includes the lower rear end part 6d of the guide bar 6, the outer cover plate 72 is in contact with the right surface of the guide bar 6, and the rear end 72a of the outer cover plate 72 is positioned rearward of the rear end 6b of the guide bar 6 (here, the lower rear end part 6d). These configurations can suppress the entry of cutting debris into the space SP2.

As illustrated in FIG. 7, the rear end 72a of the outer cover plate 72 is positioned rearward of the rear end 6b of the guide bar 6 and in proximity to the sprocket 64.

As illustrated in FIG. 13, the sprocket cover 20 comprises an abutting rib 20f protruding inward from the step part 20d or the wall 20e and has the outer shape substantially the same as the outer shape of the outer cover plate 72. The abutting rib 20f is in abutment with an entirety of the outer surface of the outer cover plate 72.

As illustrated in FIGS. 10, 11, a rear end part 72b of the outer cover plate 72 and the abutting rib 20f of the sprocket cover 20 are arranged in the space SP2. Because the space SP2 is occupied by the rear end part 72b of the outer cover plate 72 and the abutting rib 20f of the sprocket cover 20, the entry of cutting debris into the space SP2 and/or stagnation of the cutting debris in the space SP2 can be suppressed. In the present embodiment, a distance in the left-right direction between the outer cover plate 72 and the right surface of the guide bar 6 is 3mm or less. Due to this, the entry of cutting debris into the space SP2 and/or stagnation of the cutting debris in the space SP2 can be effectively suppressed. In a modification, additionally to or alternatively to the distance between the outer cover plate 72 and the right surface of the guide bar 6, the distance in the left-right direction between the step part 20d of the sprocket cover 20 and the right surface of the guide bar 6 may be 3mm or less. In this case, the step part 20d of the sprocket cover 20 may be in contact with or nearly in contact with the right surface of the guide bar 6. According to this configuration also, the entry of cutting debris into the space SP2 and/or stagnation of the cutting debris in the space SP2 can be effectively suppressed.

As illustrated in FIG. 8, when the chain saw 2 is viewed from the right side, a lower end BU of the battery pack BT is positioned above a center line CL1 of the guide bar 6. The center line CL1 herein mentioned refers to a line extending in the front-rear direction at the center in the up-down direction of the guide bar 6. As illustrated in FIG. 9, when the chain saw 2 is viewed from the right side, a distance L from a reference line RL which is an extension of a center line CL2 at the front end grip part 24d of the top handle 24 to the lower end BU of the battery pack BT is equal to or less than 2.6 times a width W of the front end grip part 24d of the top handle 24 in a direction perpendicular to the center line CL2. The center line CL2 herein mentioned refers to a line passing through the center between the upper surface and the lower surface (excluding a projection 31) of the front end grip part 24d of the top handle 24 at a position at which the projection 31 is located on the lower surface of the front end grip part 24d of the top handle 24. The projection 31 is positioned rearward of the trigger switch 30. Thus, in a chain saw 2 without such projection 31, the center line CL2 as aforementioned may be a line passing through the center between the upper surface and the lower surface of the front end grip part 24d of the top handle 24 at a position directly rearward of the trigger switch 30 (e.g., 1mm rearward from the trigger switch 30) disposed on the lower surface of the front end grip part 24d of the top handle 24.

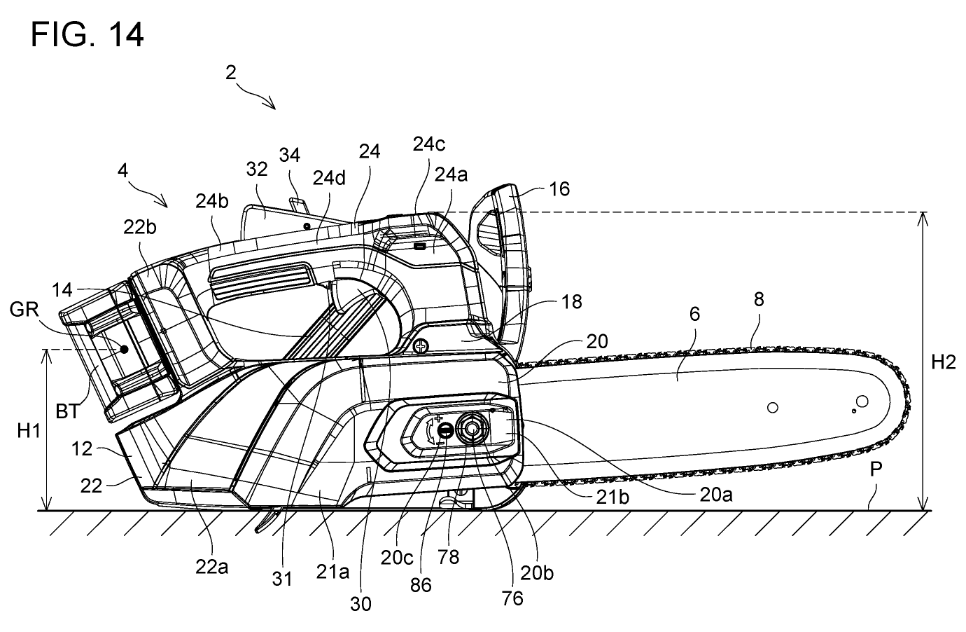

As illustrated in FIG. 14, in a state where the chain saw 2 is placed on a resting surface P, a height H1 of a center of gravity GR of the battery pack BT from the resting surface P in a vertical direction is equal to or more than a half of a height H2 of the upper end of the top handle 24 from the resting surface P in the vertical direction. The upper end of the top handle 24 herein mentioned refers to the highest position in the vertical direction from the resting surface P among the support part 24a and the grip part 24b that are formed by the left housing 10 and the right housing 12. That is, when the upper end of the top handle 24 is determined, the trigger lock lever 32 and the lock pin 34 are not considered.

### Modifications

When the chain saw 2 is viewed from the rear side, the motor 36 may not overlap the control device 42.

When the chain saw 2 is viewed from below, the battery pack BT may not overlap the control device 42.

The battery pack BT may be configured to be detachably attached to the body housing by ways of a method other than sliding, such as insertion into a battery pack casing.

The motor 36 may be a DC brushless motor with an inner rotor. Alternatively, the motor 36 may be a brushed motor or may be another type of power motor.

The inner sprocket cover 21a and the outer sprocket cover 21b may be integrally configured with each other.

Given the above, in one or more embodiments, the chain saw 2 comprises: the saw chain 8; the guide bar 6 extending in the front-rear direction and to which the saw chain 8 is attached; the sprocket 64 configured to have the saw chain 8 run along the periphery of the guide bar 6; the motor 36 configured to rotate the sprocket 64 about the rotation axis AX extending in the left-right direction; the battery pack BT configured to supply electric power to the motor 36; the body housing 22 which accommodates the motor 36 and holds the guide bar 6; and the top handle 24 disposed above the body housing 22 and configured to be gripped by a user. When the chain saw 2 is viewed from the right side, the lower end BU of the battery pack BT is positioned above the center line CL1 of the guide bar 6.

In the above configuration, since the battery pack BT, which is a heavy object, is positioned relatively close to the reference line RL which is an extension of the center line CL2 of the top handle 24, moment of inertia around the top handle 24 is small.

In one or more embodiments, the chain saw 2 comprises: the saw chain 8; the guide bar 6 extending in the front-rear direction and to which the saw chain 8 is attached; the sprocket 64 configured to have the saw chain 8 run along the periphery of the guide bar 6; the motor 36 configured to rotate the sprocket 64 about the rotation axis AX extending in the left-right direction; the battery pack BT configured to supply electric power to the motor 36; the body housing 22 which accommodates the motor 36 and holds the guide bar 6; and the top handle 24 disposed above the body housing 22 and configured to be gripped by a user. In the state where the chain saw 2 rests on the resting surface P, the height H1 of the center of gravity GR of the battery pack BT in the vertical direction from the resting surface P is equal to or more than a half of the height H2 of the upper end of the top handle 24 in the vertical direction from the resting surface P.

With the above configuration also, since the battery pack BT, which is a heavy object, is positioned relatively close to the reference line RL which is an extension of the center line CL2 of the top handle 24, moment of inertia around the top handle 24 is small.

In one or more embodiments, the chain saw 2 comprises: the saw chain 8; the guide bar 6 extending in the front-rear direction and to which the saw chain 8 is attached; the sprocket 64 configured to have the saw chain 8 run along the periphery of the guide bar 6; the motor 36 configured to rotate the sprocket 64 about the rotation axis AX extending in the left-right direction; the battery pack BT configured to supply electric power to the motor 36; the body housing 22 which accommodates the motor 36 and holds the guide bar 6; and the top handle 24 disposed above the body housing 22 and configured to be gripped by a user. The trigger switch 30 configured to be operated by the user is disposed on the lower surface of the front end grip part 24d (example of a front end) of the top handle 24. When the chain saw 2 is viewed from the right side, the distance L from the reference line RL which is extension of the center line CL2 at the front end grip part 24d of the top handle 24 to the lower end BU of the battery pack BT is equal to or less than 2.6 times the width W of the front end grip part 24d of the top handle 24 in the direction perpendicular to the center line CL2.

With the above configuration also, since the battery pack BT, which is a heavy object, is positioned relatively close to the reference line RL which is an extension of the center line CL2 of the top handle 24, moment of inertia around the top handle 24 is small.

In one or more embodiments, the chain saw 2 further comprises the control device 42 configured to control operation of the motor 36. When the chain saw 2 is viewed from the rear side, the motor 36 at least partially overlaps the control device 42.

In the above configuration, the dimensions of the chain saw 2 in the up-down direction can be made smaller.

In one or more embodiments, the chain saw 2 further comprises the control device 42 configured to control operation of the motor 36. When the chain saw 2 is viewed from below, the battery pack BT at least partially overlaps the control device 42.

In the above configuration, the dimensions of the chain saw 2 in the front-rear direction can be made smaller.

In one or more embodiments, the battery pack BT is configured to be detachably attached to the body housing 22 by being slid in the left-right direction.

In the above configuration, the user can attach and detach the battery pack BT to and from the body housing 22 by sliding the battery pack BT in the left-right direction.

What is claimed is:

1. A chain saw comprising:
a saw chain;
a guide bar extending in a front-rear direction and to which the saw chain is attached;
a sprocket configured to have the saw chain run along a periphery of the guide bar;
a motor configured to rotate the sprocket about a rotation axis extending in a left-right direction;
a battery pack configured to supply electric power to the motor;
a body housing which accommodates the motor and holds the guide bar; and
a top handle disposed above the body housing and configured to be gripped by a user,
wherein when the chain saw is viewed from a right side, a lower end of the battery pack is positioned above a center line of the guide bar.

2. A chain saw comprising:
a saw chain;
a guide bar extending in a front-rear direction and to which the saw chain is attached;
a sprocket configured to have the saw chain run along a periphery of the guide bar;
a motor configured to rotate the sprocket about a rotation axis extending in a left-right direction;
a battery pack configured to supply electric power to the motor;
a body housing which accommodates the motor and holds the guide bar; and
a top handle disposed above the body housing and configured to be gripped by a user,
wherein in a state where the chain saw rests on a resting surface, a height of a center of gravity of the battery pack in a vertical direction from the resting surface is equal to or more than a half of a height of an upper end of the top handle in the vertical direction from the resting surface.

3. A chain saw comprising:
a saw chain;
a guide bar extending in a front-rear direction and to which the saw chain is attached;
a sprocket configured to have the saw chain run along a periphery of the guide bar;
a motor configured to rotate the sprocket about a rotation axis extending in a left-right direction;
a battery pack configured to supply electric power to the motor;
a body housing which accommodates the motor and holds the guide bar; and
a top handle disposed above the body housing and configured to be gripped by a user,
wherein a trigger switch configured to be operated by the user is disposed on a lower surface of a front end of the top handle, and
when the chain saw is viewed from a right side, a distance from a reference line which is extension of a center line at the front end of the top handle to a lower end of the battery pack is equal to or less than 2.6 times a width of the front end of the top handle in a direction perpendicular to the center line.

4. The chain saw according to claim 1, further comprising a control device configured to control operation of the motor,
wherein when the chain saw is viewed from a rear side, the motor at least partially overlaps the control device.

5. The chain saw according to claim 1, further comprising a control device configured to control operation of the motor,
wherein when the chain saw is viewed from below, the battery pack at least partially overlaps the control device.

6. The chain saw according to claim 1, wherein the battery pack is configured to be detachably attached to the body housing by being slid in a left-right direction.

7. The chain saw according to claim 1, wherein in a state where the chain saw rests on a resting surface, a height of a center of gravity of the battery pack in a vertical direction from the resting surface is equal to or more than a half of a height of an upper end of the top handle in the vertical direction from the resting surface,
a trigger switch configured to be operated by the user is disposed on a lower surface of a front end of the top handle,
when the chain saw is viewed from a right side, a length from a reference line which is extension of a center line at the front end of the top handle to a lower end of the battery pack is equal to or less than 2.6 times a width of the front end of the top handle in a direction perpendicular to the center line,
the chain saw further comprises a control device configured to control operation of the motor,
when the chain saw is viewed from a rear side, the motor at least partially overlaps the control device,
when the chain saw is viewed from below, the battery pack at least partially overlaps the control device, and
the battery pack is configured to be detachably attached to the body housing by being slid in a left-right direction.

8. The chain saw according to claim 2, further comprising a control device configured to control operation of the motor,
wherein when the chain saw is viewed from a rear side, the motor at least partially overlaps the control device.

9. The chain saw according to claim 2, further comprising a control device configured to control operation of the motor,
wherein when the chain saw is viewed from below, the battery pack at least partially overlaps the control device.

10. The chain saw according to claim 2, wherein the battery pack is configured to be detachably attached to the body housing by being slid in a left-right direction.

11. The chain saw according to claim 3, further comprising a control device configured to control operation of the motor,
wherein when the chain saw is viewed from a rear side, the motor at least partially overlaps the control device.

12. The chain saw according to claim 3, further comprising a control device configured to control operation of the motor,
wherein when the chain saw is viewed from below, the battery pack at least partially overlaps the control device.

13. The chain saw according to claim 3, wherein the battery pack is configured to be detachably attached to the body housing by being slid in a left-right direction.
